(19) United States
(12) Patent Application Publication
(10) Pub. No.: US 2007/0181201 A1
(43) Pub. Date: Aug. 9, 2007

(54) Cementitious pipes

(75) Inventors: Stephen D. Baker, New South Wales (AU); John Terry Gourley, Victoria (AU); Henrik Stang, Naerum (DK)

Correspondence Address: NORRIS, MCLAUGHLIN & MARCUS, 875 THIRD AVE, 18TH FLOOR, NEW YORK, NY, 10022, US

(73) Assignee: ROCLA PTY LTD, Chatswood, New South Wales (AU)

(21) Appl. No.: 10/595,869

(22) PCT Filed: Nov. 19, 2004
(86) PCT No.: PCT/AU04/01611

§ 371 Date: Mar. 16, 2007

(30) Foreign Application Priority Data
Nov. 19, 2003 (AU) 2003906380

(51) Int. Cl. F16L 9/18

(52) U.S. Cl. 138/113

(57) ABSTRACT

A cementitious pipe as a tubular wall of fibre-reinforced cementitious pseudo strain hardening (PSH) matrix. The matrix and a wall thickness to diameter ratio within a range are such that the pipe exhibits characteristic behaviour in diametral quasi-static bending under a 3-edge bearing method. The behaviour is such that a stress versus relative displacement curve for the pipe exhibits a substantially linear elastic region having a first slope within first limits, and from the LOP to the MOR for the pipe, a PSH region which, beyond a possible transition region, has a slope which is less than that of the elastic region and is within second limits.

### FIELD OF THE INVENTION

The invention relates to cementitious pipes, suitable for below ground use.

### BACKGROUND TO THE INVENTION

Standard concrete pipes, usually steel reinforced, are produced by a number of different processes. These include centrifugal spinning in horizontally disposed moulds, and dry cast, packerhead and tamp processes conducted in vertical moulds or forms. In each of these processes vibration is important for achieving good compaction. Relatively dry mixes are used in each case, although there is a variant of the processes of vertical form in which a wet mix is directed between inner and outer forms by a conical guide.

The standard pipes are produced from mixes comprising cement, sand, stone and water. In these broad terms, the mixes have remained unchanged over the best part of the last 100 years apart from adoption, where warranted, of new types of portland cement and the possible inclusion of a proportion of pozzolanic material such as fly ash as part of the cementitious binder.

An alternative form of concrete pipe evolved from the Hatchek/Mazza process. In this, fibre-reinforced concrete (FRC) pipes are produced by laying up under pressure, on a cylindrical mandrel, a number of laminations of a mix of cement, fine silica, fibre and water to produce green pipes which are cured by steam curing or autoclaving. The fiber initially used was asbestos but, after use of asbestos was prohibited, the process was adapted for use of cellulose and plastics fibre.

The standard concrete pipes are rigid and have high compressive strengths. Their strength is due in part to the low water content of the mixes used. In the case of the standard pipes produced by centrifugal moulding, there can be an initial water/cement weight ratio of about 0.35 to 0.38 which is reduced to about 0.32 to 0.35 during spinning of the mould. However, their strength also results from their substantial wall thickness and, hence, relatively high consumption of raw materials.

The FRC pipes also are rigid and, due to the fibre-reinforcement, can have a level of compressive strength comparable to that of the concrete in steel reinforced standard pipes. Additionally, they have an advantage in being more easily produced in larger lengths. However, for a given diameter and wall thickness, they can be relatively expensive to produce due to a higher cost per unit length for the laying up procedure required. Also, when cellulose fibres are used, they can be more prone to degradation of their physical properties with age and they can tend to delaminate under high loads, particularly after long exposure to ground water.

### BROAD SUMMARY OF THE INVENTION

The present invention is directed to providing an alternative form of cementitious pipe of a type suitable for below ground use.

A cementitious pipe according to the present invention is made of a fiber-reinforced cementitious material. It has a tubular wall of a wall thickness to diameter ratio which is within a required range. The cementitious material and required range for that ratio are such that the pipe exhibits characteristic behaviour in diametral quasi-static bending (flexure) when subjected to the 3 edge bearing test method. The behaviour is such that a resultant stress versus relative displacement curve exhibits a substantially linear elastic region having a slope within first required limits and, from the limit of proportionability (LOP) for the elastic region to the modulus of rupture (MOR), a pseudo strain hardening (PSH), region which, beyond a possible transition region, has is a slope which is less than that of the elastic region and is within second required limits.

A pipe according to the present invention has a relatively low wall thickness to internal diameter ratio. For a given pipe diameter, the wall thickness is a relatively narrow range, with wall thickness range increasing with increase in diameter. Illustrative examples of wall thickness ranges relative to the internal diameters for standard pipe sizes are as follows:

| | Wall Thickness - General | | Wall Thickness - Preferred | |
|---|---|---|---|---|
| Pipe Diameter | Minimum | Maximum | Minimum | Maximum |
| 225 mm | 5 mm | 9 mm | 6 mm | 8 mm |
| 375 mm | 8 mm | 15 mm | 9 mm | 13 mm |
| 750 mm | 16 mm | 30 mm | 20 mm | 26 mm |
| 2100 mm | 45 mm | 85 mm | 55 mm | 75 mm |

The relatively low wall thickness to diameter ratio for the pipe of the present invention is of importance in the pipe attaining the required stress/relative displacement curve, and resultant distinctive performance characteristics. The low ratio also enables a cost-effective use of the fiber-reinforced cementitious material, and a relatively low weight for the pipe per unit length.

The illustrative examples of wall thickness ranges relative to internal diameter for standard pipe sizes are suitable for the purpose of achieving the required stress versus relative displacement curve characteristics for the pipe of the present invention. Those examples enable acceptable to excellent values for most relevant mechanically determined properties. However, attaining a suitable level of abrasion resistance, for example, tends to become more difficult to achieve at lower pipe diameters. Thus, for a pipe having an internal diameter of about 225 mm, for example, it can be preferable to use a wall thickness towards the upper end of the indicated wall thickness range.

While subjected to loadings generating stress levels up to the LOP, the pipe of the invention is able to function as a rigid pipe. At loadings generating higher stress levels up to the MOR, the pipe is able to function as a flexible pipe due to the effects of strain hardening. However, some limits are applicable in respect of loadings generating stress levels in excess of the LOP, as detailed later herein.

As will be appreciated, the stress versus relative displacement curve for the pipe of the present invention is size independent. However, the curve, in particular the LOP and MOR, are not independent of the composition of the cementitious material of which the pipe is made. In this latter regard, the curve can vary with each of the composition of the matrix and the characteristics (of length, diameter, composition and volume fraction) of the fibers dispersed in the matrix. However, allowing for variations in the composition of the matrix and fibres of the cementitious material, the stress/relative displacement curve can be summarized as having the following performance characteristics, when tested by the 3 edge bearing method of Australian Standard AS4139-2003:
(a) a value for the LOP, or at the cracking strength of the matrix in initial testing (if the LOP is difficult to discern due to a gradual deviation from linearity), of from about 4 to 12 MPa, such as from about 5 to 10 MPa, but more usually from about 5 to 7 MPa;
(b) a relative displacement (δ₁) at the limit of elastic deformation of from about 0.3% to about 0.9% such as from about 0.4% to 0.8% but more usually from about 30 0.6% to 0.8%;
(c) a possible first part of the PSH region of the curve, referred to as a transition part, which, if present, can range up to a relative displacement (δ₂) of about 1.7%, such as from about 1.1% to 1.5% and usually about 1.2%;
(d) a major part of the PSH region (or substantially the complete PSH region in the absence of a possible transition part) which ranges up to a displacement δ₃) of about 11%, usually within the range of from about 2% to about 11%, such as from about 3% to 10%, for example from about 5% to about 9%; and
(e) an MOR of from about 10 to 20 MPa, such as from about 10 to 17 MPa and usually from about 10 to 15 MPa, such as about 11 to 15 MPa.

As a consequence of these characteristics, the stress/relative displacement curve for a pipe according to the invention has further distinctive characteristics. The first of these is a slope (S₁) over the linear portion of the curve, within the above-mentioned first limits, of from about 1000 to 1700 MPa, such as from 1000 to 1650 MPa, for example from 1330 to 1650 MPa. The second further characteristic is that the major part of the PSH region (or substantially the complete PSH region in the absence of a possible transition part) has a positive slope (S₃) which can range, within the above-mentioned second limits, from a very small value up to about 0.04 S₁to 0.25 S₁, such as about 0.05 S₁. This second further characteristic is unusual in its relatively narrow range. However, it also is believed to be unique in being applicable to the pipe of the invention when tested by the 3 edge bearing method of AS4139-2003 in a dry state, as well as in a wet state.

The above-mentioned possible transition part of the PSH region of the stress/relative displacement curve is a relatively short transition part of the curve extending from and beyond the LOP. The transition part, if present, is of arcuate form and thus progressively decreases in slope from the slope of the substantially linear elastic region, to the slope of the major part of the PSH region. Also, it will be appreciated that while the elastic region of the curve generally is of substantially smooth linear form, the PSH part fluctuates rapidly in amplitude, reflecting the micro-cracking of the strain hardening behaviour. Thus, it is to be understood that the reference to a slope for the PSH region of the stress/relative displacement curve is a reference to the slope of a smoothed trend line for that region.

The fibre-reinforced material of which the pipe is made necessarily is one capable of exhibiting pseudo strain hardening behaviour. In this, loads in excess of the cracking strength of the cementitious matrix of the pipe result in the formation of multiple, closely spaced minute cracks as the pipe flexes under the load. Initial cracks formed when the load reaches the matrix cracking strength do not increase in width due to the cracks being bridged by fibers. Instead, other micro-cracks develop throughout the matrix as the applied load increases above the cracking strength as the pipe is caused to flex further.

On reduction or removal of a load generating microcracks, the pipe is able to recover towards, or substantially to, its unflexed condition. As this occurs, the microcracks are closed substantially. Where permitted by time, autogenous healing of cracks can occur with the formation of calcium carbonate by the action of carbon dioxide on free lime, and on calcium hydroxide resulting from curing of the cementitious material of which the pipe is made. Where autogenous healing occurs, the repaired cracks can be stronger than the surrounding cementitious matrix. Thus autogenous healing can be an important feature of the pipe of the present invention, subject to it not resulting in excessive embrittlement of the matrix. However, particularly where the pipe is subjected to intermittent or cyclical loading, the opportunity for autogenous healing can be limited.

An underground pipe is typically subjected to three types of loading. These are the live loads experienced during production, transportation and installation, the static or dead load of the soil (and any permanent installations on the soil surface) and the varying load on the soil surface, typically related to traffic wheel loads (live load). During installation the pipe will be subjected to its own self-weight in lifting operations and to impact or short duration loads from various tools during the backfilling operation (the placing of sand and soil when filling the trench in which the pipe is placed). The load on the pipe due to the self-weight of the soil depends on the soil density, the width of the trench above the pipe obvert and the depth of the pipe within the soil. The influence of the intermittent wheel load at the soil surface depends highly on the depth to which the pipe is buried. The degree to which this live load and the static dead load contribute to the critical load on the pipe varies differently with depth (i.e. as the depth increases, the static load component increases, but the live load component decreases).

The loads experienced by a pipe during production, transportation and installation can be substantial. However, in general, they are able to be accommodated by a pipe according to the present invention. As with any pipe, it is necessary that loads to which a pipe is subjected, including those experienced prior to completion of installation, generate stress levels which, with respect to the stress versus relative displacement curve, are less than the modulus of rupture. That is, the loads necessarily need to be less than a level at which resultant stress will enable macrocracking and consequent composite failure.

The pipe of the present invention is able to accommodate loads which generate stress levels within the linear elastic region of its stress/relative deflection curve. Also, within that region, repeated application of loads can be accommodated. However, it is desirable that appropriate care is taken during production, transportation and installation, to ensure that loads experienced are not such as to generate permanent stress levels beyond the LOP. It is desirable that any load resulting in a stress excursion above the LOP does not result in relative displacement of the pipe of more than 10%, and preferably in relative displacement of not more than 6%. A one-off overload providing a displacement up to about 10% can be accommodated but, as indicated, frequent stress excursion into the PSH region should be avoided if possible by care in handling and installing the pipe.

Assuming appropriate care during production, transporting and installation, the service life of the pipe according to the present invention, once installed, will be determined by its capacity to accommodate the dead load and the component of the live traffic load experienced by the buried pipe. These dead and traffic loads need to be combined and considered as an aggregate quasi static and cyclical loading.

For a given traffic load at ground level, the resultant cyclical loading on a below-ground pipe will decrease with increase in the depth at which the pipe is installed. However, the dead load of the soil increases with the depth of installation, while the depth of installation depends in part on the diameter of the pipe, drainage requirements and location. It is required that the peak load to which the pipe is exposed following installation, i.e. the maximum of the static and cyclic loads in aggregate, is such as to result in a relative displacement of the buried pipe of not more than about 1.5%. Preferably, the peak load is such as to result in a relative displacement of not more than about 1.1%. These limits apply whether or not the stress/relative displacement curve includes a possible first or transition part of the PSH region.

The pipe may be of substantially circular cross-section. However, it should be noted that the pipe need not be of substantially circular cross-section. Thus, the pipe may, for example, have a somewhat elliptical or even an ovate cross-section. Also, the wall thickness need not be uniform, but may vary circumferentially in a manner enhancing strength and, hence, the load supporting capability of the pipe. In any event, the pipe is of substantially constant cross-sectional form substantially throughout its length.

The cementitious matrix of the pipe may be based on Portland cement, although other cements can be used. The matrix may also include mineral additives and pozzolanic materials, such as flyash, silica fume and/or slag. In another form, the brittle matrix may comprise an alkali-active cement based on flyash, silica fume, slag or other pozzolanic material or mixture. Preferably, the matrix includes both Portland and alkali active cement. The pipe also has discontinuous fibres dispersed through the brittle matrix. The fibres may be of metallic, polymeric, ceramic, or other organic or mineral material, either in single fibers or strands and with or without surface or shape enhancements. It is preferred that the fibres are relatively short, such as from 3 mm to 24 mm in length. It also is preferred that the fibres have a high length to diameter aspect ratio, such as resulting from a fibre diameter of less than 200 μm , such as about 50 μm and below.

However, as detailed above, the cementitious material is one able to exhibit pseudo strain hardening behaviour by microcracking of the matrix. As such the material is limited to particular classes of high performance fiber reinforced concrete (HPFRC) materials. Engineered cementitious composite (ECC) materials are the preferred such material. The term “ECC material” usually is used to denote a material which, although based on constituents similar to those of fiber reinforced concretes (FRC), such as water, cement, sand, fiber and chemical additions, has combinations of the constituents based on micromechanical modelling to achieve significantly enhanced mechanical properties. Coarse aggregate is not used, while carefully selected, smaller fiber volume fractions are used. Additionally, the modelling allows for selection of properties of the fibers, the cementitious matrix and the interface between the fibers and the matrix. In the further description of the invention, reference principally is to ECC materials, although it is to be understood that other cementitious materials exhibiting pseudo strain hardening behaviour can be used.

The ECC material of which the pipe is made can vary to a significant extent. It may for example be based on a material composition which, in terms of weight fractions of constituents of the matrix, is selected from:

| | |
|---|---|
| Cement | 0.3 to 0.8 |
| Pozzolanic material | 0.1 to 0.3 |
| Particulate material | 0.1 to 0.4 |
| Water | 0.1 to 0.45. |

The ECC material usually includes a Portland cement, such as a general purpose grade or high early strength grade, in combination with at least one pozzolanic material in a ratio by weight of 0.35 to 1 parts, such as of 0.4 to 1 parts, of pozzolanic material to 1 part of cement. The material also includes fine particulate material, such as fine sand and quartz powder. The fine particulate material may have a particle size less than 1 mm, such as less than 0.1 mm, while it preferably is present in a ratio by weight 0.2 to 0.6 for each part of binder (cement plus pozzolanic material). The fibres may be present at from about 1 to 5 vol % with respect to total solids, and may be selected from mineral fibers, organic fibers and, to an extent depending on the method of production of the pipe, metallic fibers such as steel fibers. Polymeric fibers are preferred and, suitable examples include polypropylene, polyvinyl acetate, polyvinyl alcohol, polyethylene, polyamide, polyimide, polyacrylonitrile fibers and blends of such fibers.

The solids of the ECC material are mixed with sufficient water plus, if required, a dispersing agent and/or superplasticiser, to produce a mix suitable for the chosen method of production. While a number of production methods can be used, extrusion is most highly preferred. It is found that extrusion is the most suitable production technique for attainment of the form and physical properties required in the pipe of the present invention. For extrusion, the solids of the ECC material are mixed with sufficient water to provide a workable homogeneous mixture which, during extrusion, is able to be dewatered to provide extruded pipe lengths which have sufficient green strength to undergo removal from the extruder and handling in production lengths without distortion. For this, the mixture supplied to the extruder may have a weight ratio of water to binder (cement plus pozzolanic material) of about 0.3 to 0.5, with this being substantially reduced by dewatering. During extrusion the water/binder ratio may be reduced down to about 0.2 or lower but generally is from about 0.24 to 0.26.

The substantial dewatering to be achieved during extrusion limits the apparatus by which extrusion is able to be achieved. A suitable form of apparatus is one based on the principles disclosed in International patent specification W096/01726, corresponding to U.S. Pat. No. 6,398,998, to Krenchel et al, the disclosure of which is hereby incorporated in and to be read as part of the present disclosure.

With appropriate dewatering, the extrusion results in extruded pipe lengths which, when cured, provide pipes which exhibit a high level of compaction (high material density) and abrasion resistance. Also, the pipe has excellent strength properties and mechanical behavior in terms of elastic stiffness, compressive strength, matrix crack strength, and composite failure stress and strain. Also, the pipes are able to be produced within narrow dimensional tolerances and, hence, with avoidance of dimensional inaccuracies which can result in stress concentration. Additionally, the extrusion enables the pipes to be produced to required lengths.

The dewatering during extrusion contributes to a pipe material according to the present invention having a moderate to high tensile, compressive and flexural strength.

This results from the favourable water/binder weight ratio, as well as from the high level of solids compaction produced by extrusion pressures and dewatering. Further the high compaction provides excellent fibre to matrix bond in the composite material. The moderate to high compressive strength, together with the use of fine particulates such as fine sand and quartz powder, is a principal factor contributing to the pipe having a high level of resistance to abrasion. That is, the factors giving rise to the high compressive strength also result in the high abrasion resistance. For the pipe, it is desirable that there be resistance to solid particles carried by liquid flowing along a pipeline, as well as resistance to pitting or cavitation in surface imperfections. Extrusion is found to increase resistance to each of these forms of abrasion in providing an enhanced, smooth surface finish for the pipe.

Young's modulus for the material can be in the range 20 GPa to 40 GPa, while it preferably is in the range 30 to 35 GPa.

Compressive strength can be in the range of 40 to 100 MPa. It preferably is in the range of 45 to 75 MPa, and more preferably in the range of 50 to 70 MPa.

Matrix crack strength can be in the range of 4 to 12 MPa. It preferably is in the range of 5 to 10 MPa, and more preferably in the range of 5 to 7 MPa

Composite failure stress can be in the range of 5 to 14 MPa. It preferably is in the range of 6 to 12 MPa, and more preferably in the range of 6 to 9 MPa

Composite failure strain can be in the range of 2 to 8%. It preferably is in the range of 3 to 6%, and more preferably in the range of 3 to 5%.

For below ground use, the pipe must be able to withstand the installation loads normally experienced during the pipe laying procedure (including occasional over-loading) and be able to withstand design static and cyclic trench loads for the design life of the pipe.

The pipe will vary in stiffness with material stiffness, pipe dimensions of diameter and wall thickness and the load to which it is subjected. Under loads not exceeding the elastic range of the pipe, the pipe may have a stiffness in the range of 15,000 N/m/m to 50,000 N/m/m, such as from 15,000 N/m/m to 20,000 N/m/m. Under loads exceeding that range, the pipe may have a stiffness of from 4,000 N/m/m to 10,000 N/m/m. A transition between these two stiffness ranges may occur under a loading in the range of from 8,000 N/m/m to 20,000 N/m/m. In each case, the stiffness referred to is the secant stiffness, measured at 1% deflection, according to Australian standard AS3572.10.

The above specified required ratio of wall thickness to diameter, in combination with the mechanical properties of the material, is found to correspond to a maximum level of flexing able to be safely accommodated by the pipe in response to loading. Expressed in terms of deflection relative to diameter under diametral quasi static load, the deformation capacity can at be up to 11%, but preferably is not more than 9 or 10% and more preferably is not more than 6%. Under cyclic loading it is necessary that the pipe is subjected to a maximum cyclic load substantially less than quasi static loads. That is, the pipe will have a useful design life if the combined loading for which it is designed does not result in flexing of the pipe in excess of a designed maximum relative deflection. For amplitudes in the range from 0.4 to 0.3% a maximum deflection of 1% can be sustained, for amplitudes in the range of 0.3% to 0.1% a maximum deflection of 2% can be sustained while cyclic loading cannot be tolerated at sustained maximum deflections over 4%. Current indications are that the instantaneous maximum deflection should not exceed about 6% of the internal diameter of the pipe.

For pipe of 375 mm diameter, dimensions varying by up to 0.5 mm for wall thickness, and 5.0 mm for diameter still produce pipe of the required stiffness. Product dimensions may also be used as an adjustment for varying pipe stiffness. Statistical sampling of ring bending test data will account for any manufacturing related dimensional tolerances.

The pipe of the present invention most preferably is of an ECC material in order to enable the superior strain hardening characteristics of such a material to be utilised.

Also from a workability point of view ECC material is amenable to rational shaping by extrusion. For a given overburden/cyclical burden regime, a pipe of an ECC material and a given diameter is able to be of thinner wall thickness and, hence, to have a significantly lower raw material cost. Also, the extrusion of the pipe facilitates production of the pipe from an ECC to within narrow tolerances. The ECC materials, in comprising a paste of fine particulates containing fibers, can be difficult to handle and shape accurately by other production techniques. Also, extrusion enables avoidance of dimensional inaccuracies, which can result in stress concentration and departure from the required diametral strength for accommodating the combined overburden and cyclical load.

In order that the invention may more readily be understood, description is directed to the accompanying drawings, in which:

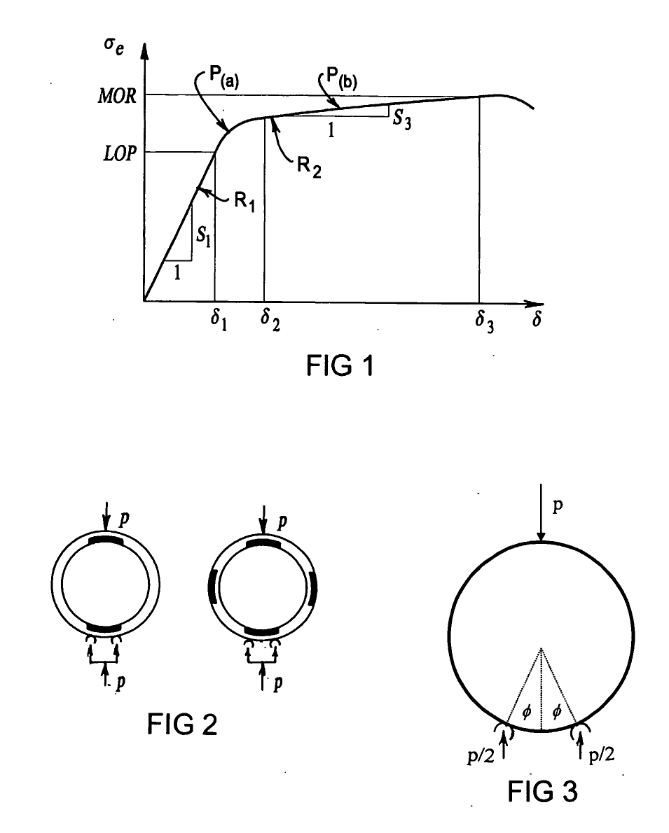

FIG. 1 is a schematic representation of a generic stress-relative displacement curve for a pipe according to the present invention;

FIG. 2 is a schematic representation of cracking of a pipe according to the present invention when subjected to respective stress levels of the curve of FIG. 1;

FIG. 3 is a schematic representation of a pipe, shown in end section, as being subjected to a 3 edge bearing test method; and

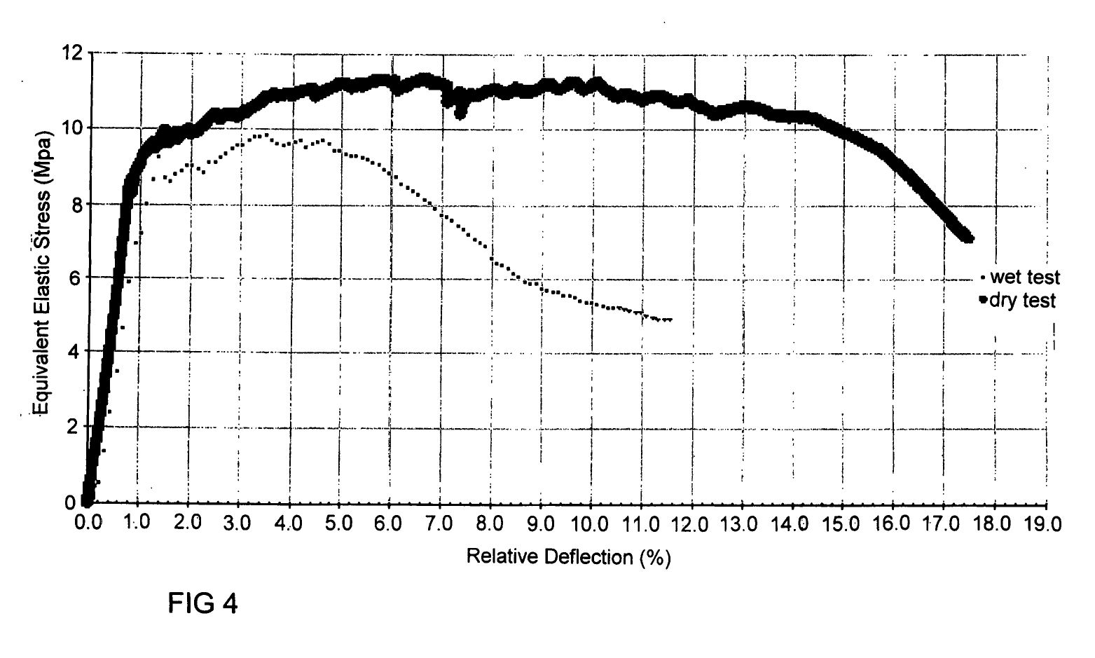

FIG. 4 shows typical experimental stress-relative displacement curves for extruded pipe of ECC material according to the present invention.

FIG. 1 has been adopted for ease of illustration of performance characteristics of a pipe according to the present invention. As indicated, FIG. 1 shows a schematic representation of stress in the pipe wall at the inner surface under the line load applied to the top of the pipe versus relative vertical displacement curve for the pipe. The curve is indicative of behaviour of the pipe in diametral, quasi-static bending (flexure) when subjected to the 3 edge bearing method of AS4139-2003. The curve is found to be representative of behaviour of the pipe in both the dry and wet state.

The pipe dimensions are characterized in terms of internal diameter, D, and wall thickness, t. Tolerances are associated to both. The external diameter D_{y} follows from: D_{y}=D+2t. The generic mechanical behavior is characterized by a stress-relative deflection curve, with the stress in the pipe wall at the inner surface under the load applied to the top of the pipe being defined by an equivalent elastic stress σₑ according to the formula:

$${σ}_{e} = k \frac{6}{π} \frac{p}{{D}_{y}} \frac{1 + \frac{D}{{D}_{y}}}{{( 1 - \frac{D}{{D}_{y}} )}^{2}}$$

where p is the line load intensity, and where k is a factor taking into account the distance between the two bottom supporting edges of the 3 edge bearing test method. For the test method of AS4139-2003 the distance is such that k for all practical purposes can be taken to be equal to 1. FIG. 3 schematically illustrates a pipe, in end elevation, as being subjected to that test method. In general the relation between k and the angle φ as shown in FIG. 3 is illustrated by the following:

φ

| | 0 | 15° | 30° | 45° |
|---|---|---|---|---|
| k | 1 | 0.98 | 0.94 | 0.88 |

The relative displacement, δ is calculated from:

$$δ = \frac{d}{D}$$

where d is the absolute vertical displacement measured in the pipe using linear variable differential transformers or transducers.

As shown in FIG. 1, the stress/relative displacement or deflection curve has two principal regions, R₁ and R₂. The first region R₁ is the substantially linear, elastic region, extending up to the limit of proportionality (LOP) and having a slope S₁. The second region R₂ is the pseudo strain hardening region which extends beyond region R₁ at stress levels in excess of the LOP, up to the modulus of rupture (MOR). The region R₂ has an arcuate intermediate part P(a) and a major part P(b). The part P(a) is relatively short and, in some instances, is not readily discernible. However, where present, part P(a) has a progressively declining slope leading to the slope S₃ of major part P(b). The deflection values δ₁, δ₂, and δ₃ represent respective levels of displacement attained at the stress levels of the LOP, the transition from part P(a) to part P(b) and the MOR.

General values for S₁, S₃, LOP, MOR, δ₁, δ₂, and δ₃ for the curve of FIG. 1, as determined by the 3 edge bearing method of AS4139-2003, are as detailed earlier herein.

In the region R₂, the actual stress/relative displacement curve will fluctuate rapidly due to microcracking in the cementitious matrix of the pipe during strain hardening. The curve of FIG. 1 is schematic in showing a smoothed trend line for region R₂. However this does not detract from the characteristics described.

With reference to FIG. 2, the two views shown therein are of a section through a pipe according to the present invention at successive stages of a 3 edge bearing method of AS4139-2003. The linear elastic region R₁ of the curve of FIG. 1 applies where, despite an increasing applied load, the pipe remains uncracked. The left hand view is of the pipe under an applied load giving rise to stress levels generating microcracking and pseudo strain hardening, and relative displacement greater than δ₁ but not more than δ₂ as δ₁ and δ₂ are shown in FIG. 1. Under these conditions, the microcracking is generated in top and bottom areas (a) and (b) of the inner surface layer of the pipe wall. As the load increases to cause relative displacement levels approaching δ₂, the areas (a) and (b) increase in size by circumferential spread around the inner surface with progressive flexing of the pipe.

The right hand view of FIG. 2 shows the situation that has developed after the applied load has increased to a level resulting in relative displacement in excess of δ₂. At a relative displacement just in excess of δ₂, microcracking begins at lateral areas (c) and (d) of the outer surface layer, on the horizontal mid-section of the pipe. As the load increases further, to result in higher levels of relative displacement less than δ₃, the areas (c) and (d) similarly increase in size with progressive flexing of the pipe.

Typical experimental stress-relative displacement curves for extruded pipe made of ECC material in accordance with the characteristics explained above for the present invention are shown in FIG. 4. The curves relate to pipe with inner diameter of 375 mm and a wall thickness of 12 mm. Data obtained both in dry and wet state of the pipe are represented. Curves of similar characteristics have been obtained testing pipe with inner diameter of 750 mm and a wall thickness of 22 mm, verifying the size independence of the pipe characteristics.

Finally, it is to be understood that various alterations, modifications and/or additions may be introduced into the constructions and arrangements of parts previously described without departing from the spirit or ambit of the invention.

1. A cementitious pipe suitable for below ground use, wherein said pipe has a tubular wall of fibre-reinforced cementitious matrix or material capable of exhibiting pseudo strain hardening (PSH) behaviour, said wall has a wall thickness to diameter s ratio within a range, and the cementitious material and the range for said wall thickness to diameter ratio are such that the pipe exhibits characteristic behaviour in diametral quasi-static bending (flexure) when subjected to the 3-edge bearing method, and wherein said behaviour is such that a resultant stress versus relative displacement curve for the pipe when subjected to that method exhibits a substantially linear elastic region having a first slope within first limits and, from the limit of proportionality (LOP) for the elastic region to the modulus of rupture (MOR) for the pipe, a PSH region which, beyond a possible transition region, has a slope which is less than that of the elastic region and is within second limits.

2. The pipe of claim 1, wherein the wall has a relatively low wall thickness to diameter ratio.

3. The pipe of claim 1 or claim 2, wherein for a given wall diameter, the wall thickness is within a relatively narrow range, with the wall thickness range for a pipe having a wall of a given larger diameter being greater than the wall thickness range for a pipe having a wall of a given smaller diameter.

4. The pipe of claim 3, wherein the wall thickness range for a given wall internal diameter is as follows for the indicated pipe wall internal diameters:

| Wall Diameter | Wall Thickness Range |
|---|---|
| 225 mm | 5 to 9 mm |
| 375 mm | 8 to 15 mm |
| 750 mm | 16 to 30 mm |
| 2100 mm | 45 to 85 mm |

5. The pipe of claim 3, wherein the wall thickness range for a given wall internal diameter is as follows for the indicated pipe wall internal diameters:

| Wall Diameter | Wall Thickness Range |
|---|---|
| 225 mm | 6 to 8 mm |
| 375 mm | 9 to 13 mm |
| 750 mm | 20 to 26 mm |
| 2100 mm | 55 to 75 mm |

6. The pipe of any one of claims 1 to 5, wherein the pipe, while subjected to loadings generating stress up to the LOP, is able to function as a rigid pipe.

7. The pipe of any one of claims 1 to 6, wherein the pipe, at loadings generating stress levels in excess of the LOP and up to the MOR is able to function as a flexible pipe due to the effects of PSH.

8. The pipe of any one of claims 1 to 7, wherein the stress versus relative displacement curve, when tested by the 3 edge bearing method of Australian Standard AS4139-2003, has a value for the LOP of from about 4 to 12 MPa, such as from about 5 to 10 MPa, for example from 5 to 7 MPa.

9. The pipe of any one of claims 1 to 7, wherein the stress versus relative displacement curve, when tested by the 3 edge bearing method of Australian Standard AS41392003, has a value at the cracking strength of the matrix in initial testing of from about 4 to 12 MPa, such as from 5 to 10 MPa, for example 5 to 7 MPa.

10. The pipe of claim 8 or claim 9, wherein said curve, when so tested, has a relative displacement (δ₁) at the limit of elastic deformation of from about 0.3% to about 0.9%, such as from 0.4 to 0.8%, for example 0.6 to 0.8%.

11. The pipe of any one of claims 8 to 10, wherein said curve when so tested, has a first, transition part of the PSH region of the curve which ranges up to a relative displacement (δ₂) of about 1.7%, such as from 1.1 to 1.5%, for example about 1.2%.

12. The pipe of any one of claims 8 to 11, wherein said curve, when so tested, has at least a major part of the PSH region which ranges up to a displacement (δ₃) of about 11%, preferably within the range of from about 2% to about 11%, such as from about 3% to 10%, for example, from about 5% to about 9%.

13. The pipe of any one of claims 8 to 12, wherein said curve, when so tested, has a MOR of from about 10 to 20 MPa, such as from about 10 to 17 MPa, for example from about 10 to 15 MPa, such as about 11 to 15 MPa.

14. The pipe of any one of claims 8 to 13, wherein said curve has a slope (S₁) over the linear portion of the curve, within said first limits, of from about 1000 MPa to about 1700 MPa, such as from 1000 MPa to 1650 MPa, for example about 1330 MPa to 1650 MPa.

15. The pipe of any one of claims 8 to 14, wherein at least a major part of the length of the PSH region of said curve has a positive slope (S₃) which ranges, within said second limits, from a very small positive value up to about 0.04 S₁ to 0.25 S₁, where S₁ is the slope of the curve over the linear portion, such as about 0.05 S₁, and wherein said PSH region fluctuates in amplitude and said slope S₃ is the slope of a smoothed trend line for the PSH region.

16. The pipe of any one of claims 1 to 15, wherein said tubular wall is of substantially circular cross-section and of substantially constant cross-sectional form substantially throughout its length.

17. The pipe of any one of claims 1 to 16, wherein the cementitious matrix is based on Portland cement and includes pozzolanic material such as flyash, silica fume, slag and combinations thereof.

18. The pipe of any one of claims 1 to 16, wherein the cementitious matrix comprises an alkali-active cement based on a pozzolanic material such as flyash, silica fume and combinations thereof.

19. The pipe of claim 17 or claim 18, wherein the cementitious matrix has discontinuous fibres dispersed therethrough, such as metallic, polymeric, ceramic fibers, and combinations thereof, in relatively short fibre length of from 3 mm to 24 mm in length.

20. The pipe of any one of claims 1 to 19, wherein the cementitious material is an engineered cementitious composite.

21. The pipe of any one of claims 1 to 20, wherein the pipe is produced by dewatering extrusion of a suitable cementitious material having a water content providing a ratio of water to binder (cement plus pozzolanic) of about 0.3 to 0.5, and wherein the ratio is reduced during extrusion to about 0.24 to 0.26.

22. The pipe of any one of claims 1 to 21, wherein the pipe has a value for Young's modulus of from 20 GPa to 40 GPa, such as from 30 GPa to 35 GPa.

23. The pipe of any one of claims 1 to 22, wherein the pipe has a compressive strength of from 40 to 100 MPa, such as from 45 to 75 MPa, for example 50 to 70 MPa.

24. The pipe of any one of claims 1 to 23, wherein the matrix crack strength is from 4 to 12 MPa, such as from 5 to 10 MPa, for example 5 to 7 MPa.

25. The pipe of any one of claims 1 to 24, wherein the pipe has a composite failure stress of from 5 to 14 MPa, such as from 6 to 12MPa, for example 6 to 9 MPa.

26. The pipe of any one of claims 7 to 25, wherein the pipe has a composite failure strain of from 2 to 8%, such as from 3 to 6%, for example 3 to 5%.

27. A method of producing cementitious pipe suitable for below ground use, wherein said method includes forming a pipe having a tubular wall of fibre-reinforced cementitious matrix or material capable of exhibiting pseudo strain hardening (PSH) behaviour, said wall having a wall thickness to diameter ratio within a range, and wherein said forming and the cementitious material are controlled whereby the range for said wall thickness to diameter ratio is such that the pipe exhibits characteristic behaviour in diametral quasi-static bending (flexure) when subjected to the 3-edge bearing method, and such said behaviour is such that a resultant stress versus relative displacement curve for the pipe when subjected to that method exhibits a substantially linear elastic region having a first slope within first limits and, from the limit of proportionality (LOP) for the elastic region to the modulus of rupture (MOR) for the pipe, a PSH region which, beyond a possible transition region, has a slope which is less than that of the elastic region and is within second limits.

28. The method of claim 27, wherein the forming is controlled such that the wall has a relatively low wall thickness to diameter ratio.

29. The method of claim 27 or claim 28, wherein forming is controlled such that the for a given wall diameter, the wall thickness is within a relatively narrow range, with the wall thickness range for a pipe having a wall of a given larger diameter being greater than the wall thickness range for a pipe having a wall of a given smaller diameter.

30. The method of claim 29, wherein forming is controlled such that the wall thickness range for a given wall internal diameter is as follows for the indicated pipe wall internal diameters:

| Wall Diameter | Wall Thickness Range |
|---|---|
| 225 mm | 5 to 9 mm |
| 375 mm | 8 to 15 mm |
| 750 mm | 16 to 30 mm |
| 2100 mm | 45 to 85 mm |

31. The method of claim 29, wherein forming is controlled such that the wall thickness range for a given wall internal diameter is as follows for the indicated pipe wall internal diameters:

| Wall Diameter | Wall Thickness Range |
|---|---|
| 225 mm | 6 to 8 mm |
| 375 mm | 9 to 13 mm |
| 750 mm | 20 to 26 mm |
| 2100 mm | 55 to 75 mm |

32. The method of any one of claims 27 to 31, wherein said forming is controlled such that the tubular wall is of substantially circular cross-section and of substantially constant cross-sectional form substantially throughout its length.

33. The method of any one of claims 27 to 32, wherein the cementitious matrix is selected from a matrix based on:
(a) Portland cement and includes pozzolanic material such as flyash, silica fume, slag and combinations thereof; or
(b) an alkali-active cement based on a pozzolanic material such as flyash, silica fume and combinations thereof.

34. The method of claim 33, wherein the cementitious matrix has discontinuous fibres dispersed therethrough, such as metallic, polymeric, ceramic fibers, and combinations thereof, in relatively short fibre length of from 3 mm to 24 mm in length.

35. The method of any one of claims 27 to 34, wherein the cementitious material is an engineered cementitious composite.

36. The method of any one of claims 27 to 39, wherein the pipe is produced by dewatering extrusion of a suitable cementitious material having a water content providing a ratio of water to binder (cement plus pozzolanic) of about 0.3 to 0.5, and wherein the ratio is reduced during extrusion to about 0.24 to 0.26.
